(19) United States
(12) Patent Application Publication
(10) Pub. No.: US 2025/0019943 A1
(43) Pub. Date: Jan. 16, 2025

(54) HOT AND COLD OUTDOOR FAUCET SYSTEM

(71) Applicant: Murray Offrey, Beaver County (CA)

(72) Inventor: Murray Offrey, Beaver County (CA)

(21) Appl. No.: 18/723,912

(22) PCT Filed: Nov. 15, 2022
(86) PCT No.: PCT/CA2022/051682

§ 371 Date: Jun. 25, 2024

(30) Foreign Application Priority Data
Nov. 18, 2021 (CA) 3139419
Nov. 15, 2022 (WO) PCT/CA2022/051682

(51) Int. Cl. E03B 9/02; F16K 11/06

(52) U.S. Cl. CPC E03B 9/027; F16K 11/06

(57) ABSTRACT

A system for supplying mixed temperature water to an exterior of a building is disclosed herein. The system includes a water mixing valve. In some embodiments, the system may also comprise an outdoor faucet, or in other embodiments, the system may be integrate with existing outdoor faucet systems. The outdoor faucet preferably includes an elongated conduit that extends through a wall of the building and attaches to the water mixing valve located on an interior of the building. As such, the outdoor faucet is prevented from freezing risks. The system provides hot, cold or warm water to the outdoor faucet, preventing an individual from having to carry water from the interior to the exterior.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of outdoor faucets of existing art and more specifically relates to a hot and cold water outdoor faucet.

### RELATED ART

A silcock, or hose bib, is an outdoor water faucet that is located on an exterior of a building. These water faucets are usually installed low on the house-typically around a sill plate of the building. Generally, outdoor water faucets are used for connecting hoses thereto or are used simply to provide water access to an exterior of the building. Outdoor water faucets are connected to the main water supply of the building. As such, a temperature of the water from an outdoor water faucet is dependent on ground temperature and ambient temperature where the main water supply line is located, which is typically cold. As such, if hot or warm water is needed outside, an individual must fill a bucket inside the house and carry the bucket outside. This is usually cumbersome, heavy work and can be dangerous if hot water spills on the individual. As such, a suitable solution is desired.

### SUMMARY OF THE INVENTION

In view of the foregoing disadvantages inherent in the known outdoor faucet art, the present disclosure provides a novel hot and cold outdoor faucet. The general purpose of the present disclosure, which will be described subsequently in greater detail, is to provide a system that provides hot and cold water to an outdoor frost free faucet.

A system for supplying mixed temperature water to an exterior of a building is disclosed herein. The building includes a hot water supply and a cold water supply. The system includes a water mixing valve and an outdoor faucet. The water mixing valve may be located in an interior of the building. The water mixing valve may include a valve body defining a valve interior and having a cold water inlet, a hot water inlet and a mixed water outlet. The cold water inlet may be configured to receive cold water from the cold water supply, the hot water inlet may be configured to receive hot water from the hot water supply, and the mixed water outlet may be configured to output mixed hot and cold water. The water mixing valve may further include a water temperature control means. The water temperature control means may be configured to control supply of the cold water and the hot water into the valve interior.

The outdoor faucet may include an elongated conduit, a spout and a handle means. The elongated conduit may be disposed at least partially within a wall of the building. The elongated conduit may be connected to the mixed water outlet at an inner end at the interior of the building, and to the spout at an outer end. The elongated conduit may be configured to selectively receive the mixed hot and cold water from the mixed water outlet and feed it to the spout, the spout being mounted to the exterior of the building and including a spout opening for expelling the mixed hot and cold water. The handle means may be in communication with an outlet control means such that movement of the handle means into a first position positions the outlet control means such that the mixed hot and cold water may be prevented from entering the elongated conduit, and movement of the handle means into a second position positions the outlet control means such that the mixed hot and cold water may be permitted entrance into the elongated conduit and out through the spout opening.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a hot and cold outdoor faucet, constructed and operative according to the teachings of the present disclosure.

FIG. 1 is a side view of a system supplying mixed temperature water to an exterior of a building, the system comprising an outdoor faucet and a water mixing valve, an elongated conduit of the outdoor faucet being fragmented and a section of the elongated conduit being cutaway, and a section of a housing covering the water mixing valve being cutaway, according to an embodiment of the disclosure.

FIG. 2A is a schematic diagram of the system attached to a cold water supply and a hot water supply of the building, according to an embodiment of the present disclosure.

FIG. 2B is a schematic diagram of a water mixing valve receiving water from the cold water supply and the hot water supply, according to an embodiment of the present disclosure.

FIG. 3 is a front view of the water mixing valve, according to an embodiment of the present disclosure.

FIG. 4 is a cross-sectional view of the water mixing valve of FIG. 3, according to an embodiment of the present disclosure.

FIG. 5 is a front view of a housing having a display and a temperature controller, according to an embodiment of the present disclosure.

FIG. 6 is a block diagram of the system, according to another embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to outdoor faucets and more particularly to a hot and cold outdoor faucet system for supplying hot and cold water to an exterior of a building, thus preventing a need for an individual to carry hot water from an interior of the building to the exterior. Generally, the hot and cold outdoor faucet system may be a frost free faucet preventing risk of freezing. The hot and cold outdoor faucet system may be controlled outside by a user, controlled inside automatically by the hot and cold outdoor faucet system, or manually controlled inside by a user. The hot and cold outdoor faucet system may be easily installable and may be retrofit with existing outdoor faucets or an outdoor faucet may be included with the hot and cold outdoor faucet system.

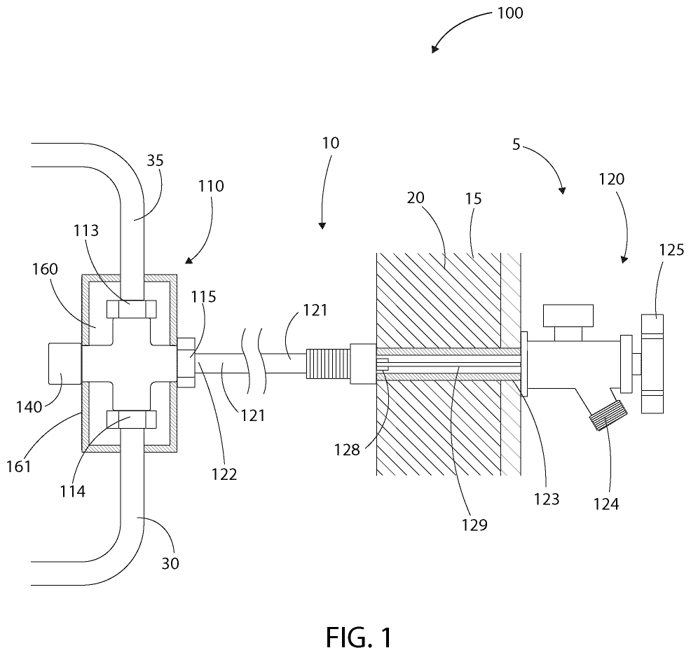

Referring now more specifically to the drawings by numerals of reference, there is shown in FIGS. 1-6, various views of a system for supplying mixed temperature water to an exterior of a building (“system” 100).

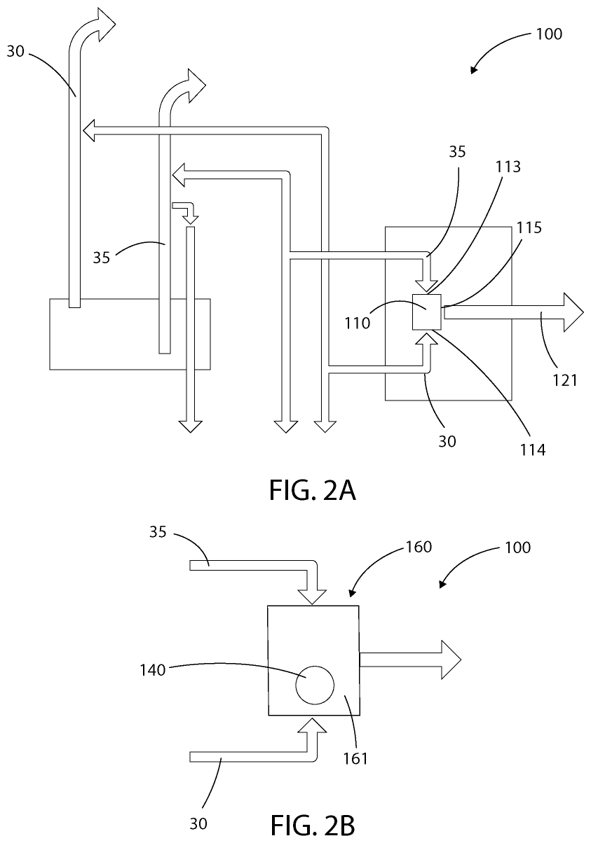

Referring specifically to FIGS. 1-2B, there is shown a water mixing valve 110 and, in some embodiments, an outdoor faucet 120 (as above, in some embodiments, the system 100 may be retrofit to existing outdoor faucet systems). The system 100 may be used for supplying mixed temperature water to an exterior 5 of a building 15. The building including a hot water supply 30 and a cold water supply 35. As above, the system 100 may provide a user with warm water when needed outside. For example, the system 100 may be used for filling buckets to wash vehicles, building window exteriors, etc. Thus, a risk of individuals getting hurt from carrying warm/hot water from an interior 10 of the building 15 may be reduced.

As shown in FIG. 1, the water mixing valve 110 may be located in an interior 10 of the building 15. The outdoor faucet 120 may include an elongated conduit 121, a spout 124 and a handle means 125. As shown, the elongated conduit 121 may be disposed at least partially within a wall 20 of the building 15 and connected to the mixed water outlet 115 at an inner end 122 thereof at the interior 10 of the building 15 and attached to the spout 124 at an outer end 123 thereof. Thus, water may always be shut off in the warmth of the interior 10 of the building 15, preventing water from collecting in the elongated conduit 121.

As shown in FIG. 1, the spout 124 may be mounted to the exterior 5 of the building 15 and may include a spout opening for expelling the mixed hot and cold water. The elongated conduit 121 is shown fragmented in FIG. 1 to illustrate a relationship between the elongated conduit 121, the water mixing valve 110 and the outdoor faucet 120 and to illustrate that whilst the elongated conduit 121 is connected to the water mixing valve 110 it is not limited to a length, nor is the water mixing valve 110 limited to location or distance relative to the outdoor faucet 120. For example, the water mixing valve 110 may be located between 5-25 ft from the outdoor faucet 120. In some embodiments, the water mixing valve 110 may be installed near to a hot water tank and/or furnace of the building 15. In other examples, the water mixing valve 110 may be installed anywhere in the building 15 with convenient access to the hot water supply 30 and the cold water supply 35. A location of the water mixing valve 110 may depend on size of building 15 and/or layout of basement in the building 15.

In some examples, the handle means 125 may include a knob. In other examples, the handle means 125 may include a lever. As shown in FIG. 1, the handle means 125 may be in communication with an outlet control means 128. The elongated conduit 121 is shown with a section cutaway to illustrate the outlet control means 128. The handle means 125 may be in communication with the outlet control means 128 so that movement of the handle means 125 into a first position positions the outlet control means 128 such that the mixed hot and cold water is prevented from entering the elongated conduit 121, and movement of the handle means 125 into a second position positions the outlet control means 128 such that the mixed hot and cold water is permitted entrance into the elongated conduit 121 and out through the spout opening.

For example, the first position may include the handle means 125 being positioned neutrally, and the second position may include the handle means 125 positioned upwardly (for example, the user may lift the handle means 125 up to receive the mixed hot and cold water-[in embodiments where the handle means 125 is a lever]). In another example the second position may include the handle means 125 being twisted to a right or left direction (in embodiments where the handle means 125 is a knob). It is contemplated that the outlet control means 128 is located on the interior 10 of the building 15 to shut water off prior to it entering the elongated conduit 121. In some embodiments, the outlet control means 128 may be a water shut-off valve utilizing a ball valve, a butterfly valve, a cartridge, movable seal, or the like. The handle means 125 may be in communication with the outlet control means 128 via a shaft 129, as shown in FIG. 1, that selectively moves the outlet control means 128 depending on a position of the handle means 125.

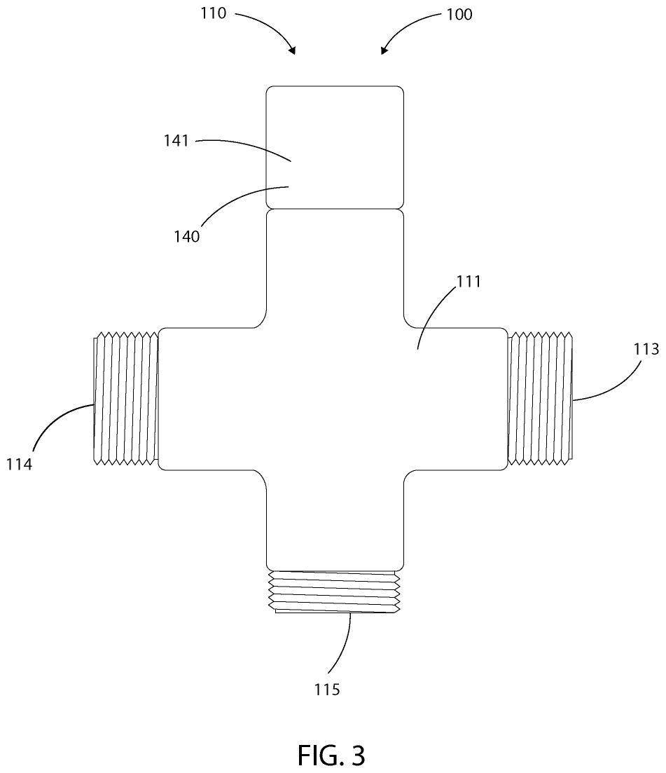

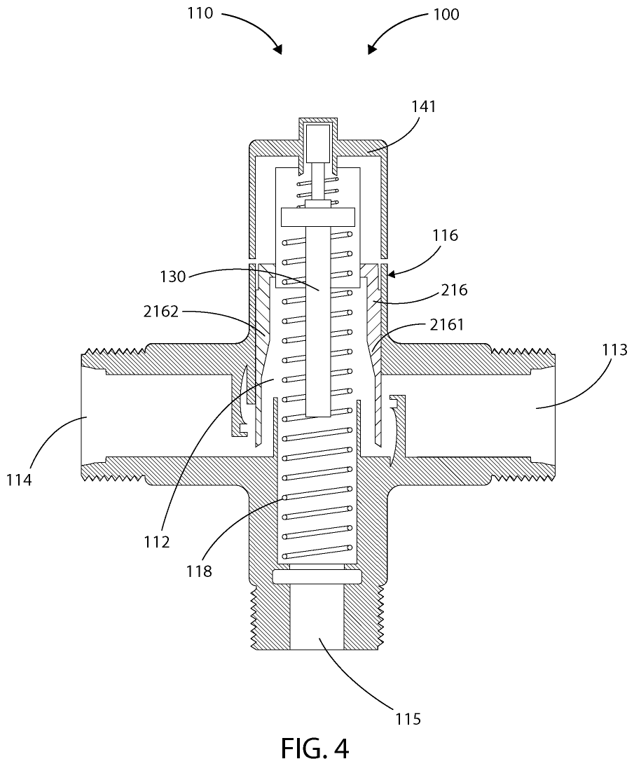

Referring specifically to FIGS. 3-4, the water mixing valve 110 may include a valve body 111 defining a valve interior 112 and having a cold water inlet 113, a hot water inlet 114 and a mixed water outlet 115. The cold water inlet 113 may be configured to receive cold water from the cold water supply 35 of the building, the hot water inlet 114 may be configured to receive hot water from the hot water supply 30 of the building, and the mixed water outlet 115 may be configured to output mixed hot and cold water. In some embodiments, the cold water inlet 113, hot water inlet 114 and the mixed water outlet 115 may include a ½ inch diameter. However, it should be appreciated that the cold water inlet 113, hot water inlet 114 and the mixed water outlet 115 may not be limited to this diameter. For example, the cold water inlet 113, hot water inlet 114 and the mixed water outlet 115 may include a diameter larger than ½ inch. The mixed hot and cold water may be mixed within the valve interior 112. The elongated conduit 121 (FIG. 1) may be configured to selectively receive the mixed hot and cold water from the mixed water outlet 115 and feed it to the spout 124 (FIG. 1).

The water mixing valve 110 may further include a water temperature control means 116. The water temperature control means 116 may be configured to control supply of the cold water and the hot water into the valve interior 112. In some embodiments, as shown in FIG. 4, the water mixing valve 110 may include a thermostatic element 130 located within the valve interior 112. Preferably, the thermostatic element 130 may be configured to expand and contract based on a temperature of the mixed hot and cold water. For example, the thermostatic element 130 may expand with hot temperatures and contract with cold temperatures. In some embodiments, the thermostatic element 130 may be a wax thermostatic element.

In this embodiment, the water temperature control means 116 may include a slidable member 216 (or equivalent type). For example, the slidable member 216 may be a sliding valve, piston valve, etc. As shown in FIG. 4, the slidable member 216 may be in communication with the thermostatic element 130, and expansion and contraction of the thermostatic element 130 may cause the movement of the slidable member 216. As shown, a return spring 118 may be located within the valve interior 112 and in communication with the slidable member 216 to aid in movement thereof.

The slidable member 216 may include a cold water side 2161 and a hot water side 2162. Movement of the slidable member 216 may selectively cause the cold water side 2161 to alter flow of the cold water into the valve interior 113 and the hot water side 2162 to alter flow of the hot water into the valve interior 112. As shown, openings of the cold water inlet 113 and the hot water inlet 114 may be staggered. For example, hot water may enter the valve interior 112 at a bottom, and cold water may enter the valve interior 112 at a top. As such, expansion of the thermostatic element 130 may move the slidable member 216 down, closing off (or at least partially closing off) the hot water inlet 114 and further opening the cold water inlet 113. Conversely, contraction of the thermostatic element 130 may move the slidable member 216 up (with help of the return spring 118), closing off (or at least partially closing off) the cold water inlet 113 and further opening the hot water inlet 114.

The system 100 may further comprise a temperature controller 140 configured for use in setting a desired temperature 152 of the mixed hot and cold water. For example, as shown in FIGS. 3-5, the temperature controller 140 may include a temperature control knob 141. The temperature controller 140 may be in communication with the water temperature control means 116. In some embodiments, the temperature controller 140 may include a keypad (not illustrated). The keypad may be instead of, or in addition to the temperature control knob 141.

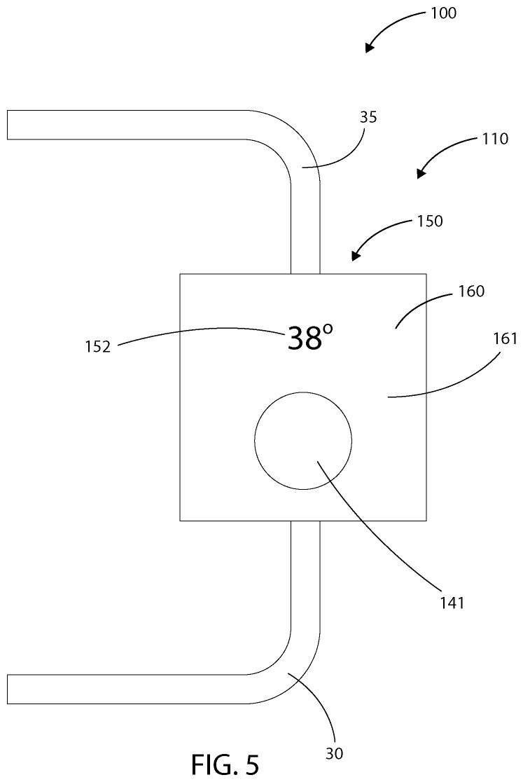

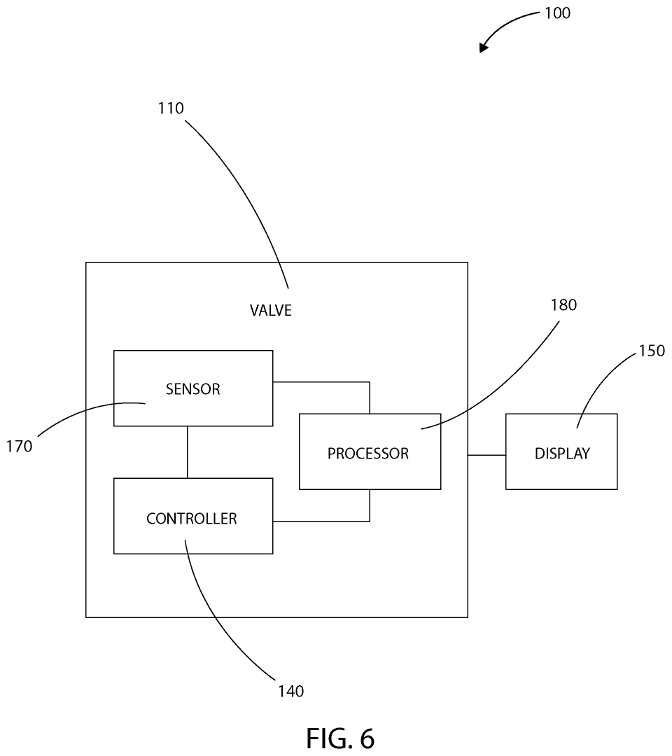

Further, as shown in FIGS. 5-6, in some embodiments, the system 100 may further comprise a display 150. For example, the display 150 may be a digital display. The display 150 may visually indicate at least a desired temperature 152, as shown in FIG. 5. Further, in some embodiments, the display 150 may visually indicate a sensed temperature. When using the temperature control knob 141 to select the desired temperature 152, temperature numbers may be visually displayed on the display 150 for the user to select. In other (or additional) embodiments, the temperature control knob 141 may include temperature indicia for indicating a plurality of temperatures for the user to select (for example, 38 degrees, 35 degrees, 30 degrees, etc.)

As shown in FIG. 5, the system 100 may further comprise a housing 160 mounted to an interior surface of the wall 20 on the interior 10 of the building 15. The water mixing valve 110 may be housed within the housing 160 (FIG. 1 shows a section of the housing 160 being cutaway to illustrate the water mixing valve 110). Preferably, the display 150 may be located on a front surface 161 of the housing 160. In this embodiment, the system 100 may further comprise a controller 180. The controller 180 may include a processor 181 for facilitating communication between electronic components of the system 100. For example, the processor 181 may facilitate the sending and receipt of signals between the temperature controller 140 and the display 150.

In addition to this, the system 100 may be configured to receive signals from an external device (not illustrated). For example, the system 100 may comprise software (such as a software application) installed on a smartphone, tablet computer, laptop computer, desktop computer, or the like. In this embodiment, the external device may be used instead of or in addition to the keypad/temperature control knob 141 for controlling the desired temperature 152. Further, in some embodiments, the housing 160 or the water mixing valve 110 may be locked via a lock mechanism (not illustrated) to prevent unauthorized tampering.

It should be appreciated that the system 100 may not be limited to use with the thermostatic element 130. In some embodiments as shown in FIG. 6, the system 100 may utilize a temperature sensor 170 (located within the valve interior 112). For example, the water temperature control means 116 may utilize control valves with motors or other actuators attached thereto for selectively closing and opening the cold water inlet 113 and the hot water inlet 114. The controller 180 may be in communication with the temperature sensor 170 and the motors (or other actuators) to facilitate communicate therebetween and cause opening/closing of the hot water inlet 114 and the cold water inlet 113 based on desired temperature 152 and/or sensed temperature. Further, in some embodiments, the handle means 125 may allow for changing of temperature of the mixed hot and cold water. This may be achieved manually and/or electronically. For example, a controller and/or sensors (not illustrated) may be located about the handle means 125 and configured to control the temperature control means 116 based on a position of the handle means 125.

It should be noted that, under appropriate circumstances, considering such issues as design preference, user preferences, marketing preferences, cost, structural requirements, available materials, technological advances, etc., other methods for providing hot and cold water to an outdoor faucet are taught herein. It should also be appreciated that in some embodiments the system may be retrofitted to existing outdoor faucets, and as such, may not include the outdoor faucet discussed above.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the Patent Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A system for supplying mixed temperature water to an exterior of a building, the building having a hot water supply and a cold water supply, the system comprising:
a water mixing valve located in an interior of the building, the water mixing valve including a valve body defining a valve interior and having a cold water inlet, a hot water inlet and a mixed water outlet, the cold water inlet configured to receive cold water from the cold water supply, the hot water inlet configured to receive hot water from the hot water supply, and the mixed water outlet configured to output mixed hot and cold water, the water mixing valve further including a water temperature control means, the water temperature control means configured to control supply of the cold water and the hot water into the valve interior;
an outdoor faucet including an elongated conduit, a spout and a handle means, the elongated conduit disposed at least partially within a wall of the building, the elongated conduit being connected to the mixed water outlet at an inner end at the interior of the building, and to the spout at an outer end, the elongated conduit being configured to selectively receive the mixed hot and cold water from the mixed water outlet and feed it to the spout, the spout being mounted to the exterior of the building and including a spout opening for expelling the mixed hot and cold water, the handle means being in communication with an outlet control means such that movement of the handle means into a first position positions the outlet control means such that the mixed hot and cold water is prevented from entering the elongated conduit, and movement of the handle means into a second position positions the outlet control means such that the mixed hot and cold water is permitted entrance into the elongated conduit and out through the spout opening.

2. The system of claim 1, further comprising a thermostatic element located within the valve interior, and wherein the thermostatic element is configured to expand and contract based on a temperature of the mixed hot and cold water.

3. The system of claim 2, wherein the water temperature control means includes a slidable member, wherein the slidable member includes a cold water side and a hot water side, wherein movement of the slidable member selectively causes the cold water side to alter flow of the cold water into the valve interior and the hot water side to alter flow of the hot water into the valve interior.

4. The system of claim 3, wherein the slidable member is in communication with the thermostatic element, and wherein expansion and contraction of the thermostatic element causes the movement of the slidable member.

5. The system of claim 4, further comprising a return spring located within the valve interior, and wherein the return spring is in communication with the slidable member to aid in movement thereof.

6. The system of claim 5, further comprising a temperature controller, the temperature controller configured for use in setting a desired temperature of the mixed hot and cold water.

7. The system of claim 6, wherein the temperature controller is in communication with the water temperature control means.

8. The system of claim 7, wherein the temperature controller includes a temperature control knob.

9. The system of claim 8, further comprising a display.

10. The system of claim 9, wherein the display visually indicates a desired temperature.

11. The system of claim 10, further comprising a housing mounted to an interior surface of the wall on the interior of the building, and wherein the mixing valve is housed within the housing.

12. The system of claim 11, wherein the display is located on a front surface of the housing.

13. The system of claim 1, further comprising a temperature sensor located within the valve interior.

14. The system of claim 13, further comprising a controller.

15. The system of claim 14, wherein the controller is in communication with the temperature sensor.

16. A system for supplying mixed temperature water to an exterior of a building, the building having a hot water supply and a cold water supply, the system comprising:
a water mixing valve located in an interior of the building, the water mixing valve including a valve body defining a valve interior and having a cold water inlet, a hot water inlet and a mixed water outlet, the cold water inlet configured to receive cold water from the cold water supply, the hot water inlet configured to receive hot water from the hot water supply, and the mixed water outlet configured to output mixed hot and cold water, the water mixing valve further including a water temperature control means and a return spring located within the valve interior, the water temperature control means configured to control supply of the cold water and the hot water into the valve interior, the water temperature control means including a slidable member, the slidable member having a cold water side and a hot water side, movement of the slidable member selectively causing the cold water side to alter flow of the cold water into the valve interior and the hot water side to alter flow of the hot water into the valve interior, the return spring in communication with the slidable member to aid in movement thereof;
a thermostatic element located within the valve interior, the thermostatic element configured to expand and contract based on a temperature of the mixed hot and cold water;
a temperature controller in communication with the water temperature control means, the temperature controller configured for use in setting a desired temperature of the mixed hot and cold water, the temperature controller including at least a temperature control knob;
an outdoor faucet including an elongated conduit, a spout and a handle means, the elongated conduit disposed at least partially within a wall of the building, the elongated conduit being connected to the mixed water outlet at an inner end at the interior of the building, and to the spout at an outer end, the elongated conduit being configured to selectively receive the mixed hot and cold water from the mixed water outlet and feed it to the spout, the spout being mounted to the exterior of the building and including a spout opening for expelling the mixed hot and cold water, the handle means being in communication with an outlet control means such that movement of the handle means into a first position positions the outlet control means such that the mixed hot and cold water is prevented from entering the elongated conduit, and movement of the handle means into a second position positions the outlet control means such that the mixed hot and cold water is permitted entrance into the elongated conduit and out through the spout opening;
wherein the slidable member is in communication with the thermostatic element, and wherein expansion and contraction of the thermostatic element causes the movement of the slidable member.

17. The system of claim 16, further comprising a display, wherein the display visually indicates the desired temperature.

18. The system of claim 17, further comprising a housing mounted to an interior surface of the wall on the interior of the building, wherein the mixing valve is housed within the housing, and wherein the display is located on a front surface of the housing.

19. The system of claim 16, further comprising a temperature sensor and a controller in communication with the temperature sensor.

20. A system for supplying mixed temperature water to an exterior of a building, the building having a hot water supply and a cold water supply, the system comprising:
a water mixing valve located in an interior of the building, the water mixing valve including a valve body defining a valve interior and having a cold water inlet, a hot water inlet and a mixed water outlet, the cold water inlet configured to receive cold water from the cold water supply, the hot water inlet configured to receive hot water from the hot water supply, and the mixed water outlet configured to output mixed hot and cold water, the water mixing valve further including a water temperature control means and a return spring located within the valve interior, the water temperature control means configured to control supply of the cold water and the hot water into the valve interior, the water temperature control means including a slidable member, the slidable member having a cold water side and a hot water side, movement of the slidable member selectively causing the cold water side to alter flow of the cold water into the valve interior and the hot water side to alter flow of the hot water into the valve interior, the return spring in communication with the slidable member to aid in movement thereof;
a housing mounted to an interior surface of the wall on an interior of the building, the mixing valve being housed within the housing;
a thermostatic element located within the valve interior, the thermostatic element configured to expand and contract based on a temperature of the mixed hot and cold water;
a temperature controller in communication with the water temperature control means, the temperature controller configured for use in setting a desired temperature of the mixed hot and cold water, the temperature controller including at least a temperature control knob;
a display located on a front surface of the housing, the display visually indicating the desired temperature;
an outdoor faucet including an elongated conduit, a spout and a handle means, the elongated conduit disposed at least partially within a wall of the building, the elongated conduit being connected to the mixed water outlet at an inner end at the interior of the building, and to the spout at an outer end, the elongated conduit being configured to selectively receive the mixed hot and cold water from the mixed water outlet and feed it to the spout, the spout being mounted to the exterior of the building and including a spout opening for expelling the mixed hot and cold water, the handle means being in communication with an outlet control means such that movement of the handle means into a first position positions the outlet control means such that the mixed hot and cold water is prevented from entering the elongated conduit, and movement of the handle means into a second position positions the outlet control means such that the mixed hot and cold water is permitted entrance into the elongated conduit and out through the spout opening; and
wherein the slidable member is in communication with the thermostatic element, and wherein expansion and contraction of the thermostatic element causes the movement of the slidable member.
